(19) United States
(12) Patent Application Publication
(10) Pub. No.: US 2019/0112147 A1
(43) Pub. Date: Apr. 18, 2019

(54) FOR OBTAINING A DIAMETER OF A MAIN ROLLER INCLUDED IN A MULTI-ROLLER MODULE SYSTEM

(71) Applicant: AUO Crystal Corporation, Taichung City (TW)

(72) Inventors: Shih-Chueh Lei, Taichung City (TW); Chan-Tien Chen, Taichung City (TW)

(21) Appl. No.: 16/142,284

(22) Filed: Sep. 26, 2018

(30) Foreign Application Priority Data
Oct. 13, 2017 (TW) 106135153

(51) Int. Cl. B65H 59/18; B23D 55/10; B23D 55/08

(52) U.S. Cl. CPC B65H 59/18; B28D 5/0058; B23D 55/086; B23D 55/10

(57) ABSTRACT

A method for obtaining a diameter is provided. The method is to be applied to a multi-roller module system and includes: designating a target linear velocity associated with a wire moving in the multi-roller module system, and a value of a presumed diameter parameter associated with a diameter of a main roller; calculating an initial rotational speed of the main roller; measuring a current rotational speed of the fixed-diameter rotating component; calculating an actual linear velocity of the wire; and determining that the value of the presumed diameter parameter equals an actual diameter of the main roller when it is determined that the ratio of the target linear velocity to the actual linear velocity is equal to one.

### CROSS-REFERENCE TO RELATED APPLICATION

This application claims priority of Taiwanese Patent Application No. 106135153, filed on Oct. 13, 2017.

### FIELD

the disclosure relates to a method for obtaining a diameter of a main roller included in a multi-roller module system.

### BACKGROUND

FIG. 1 illustrates a multi-roller module system 9, which for example may be included in a wafer dicing system. The multi-roller module system 9 includes two rotatable main rollers 91, a first tension wheel 92 and a second tension wheel 93 that are disposed respectively at two opposite sides of the main rollers 91, a first wire roller 94 disposed at an output side of the first tension wheel 92, a second wire roller 95 disposed at an input side of the second tension wheel 93, and two tension adjusting components 97.

A wire 96 is wound on the main rollers 91, the first tension wheel 92, the second tension wheel 93, the first wire roller 94 and the second wire roller 95. The tension adjusting components 97 are configured to adjust positions respectively of the first tension wheel 92 and the second tension wheel 93, respectively, so as to adjust a tension of the wire 96. As seen in FIG. 1, each one of the tension adjusting components 97 may be connected to a corresponding one of the first tension wheel 92 and the second tension wheel 93 using a linkage, and may drive the corresponding one of the first tension wheel 92 and the second tension wheel 93 to move. The broken lines indicate possible positions to which the first tension wheel 92 and the second tension wheel 93 can move.

Each of the main rollers 91 includes a covering layer that is the outermost layer of the main rollers 91, and the covering layer is formed with one or more grooves for receiving the wire 96. As such, for each of the main rollers 91, an actual diameter at a position of the main roller 91 where the wire 96 is wound thereon (i.e., a diameter of a turn of the wire 96 on the main roller 91) may be different. That is to say, with the wire 96 placed at different positions on the main roller 91, the actual diameter of the main roller 91 may be different.

FIG. 2 is a flow chart illustrating steps of a conventional method for determining the actual diameter of the main rollers.

In step S100, a target linear velocity (V_{T}) associated with the wire 96 moving in the multi-roller module system 9 is designated, and a presumed diameter (Rₛ) is inputted for estimating a rotational speed of the main rollers 91. The term “input” refers to the action of entering a numeric value for a wire-running control program for controlling operations of the multi-roller module system 9.

In step S200, the multi-roller module system 9 is activated, and the wire 96 is controlled to move along a specific direction (e.g., as indicated by the straight arrow of FIG. 1). In this motion, the wire 96 may be seen as moving away from the second wire roller 95 toward the first wire roller 94, and wounded on the first wire roller 94. It is noted that the main rollers 91, the first tension wheel 92, the second tension wheel 93, the first wire roller 94 and the second wire roller 95 may rotate at various rotational speeds due to non-uniform diameters thereof.

In step S300, an inspection is made to determine whether the first tension wheel 92, disposed between the main rollers 91 and the first wire roller 94, has moved away from a default location. When the determination is affirmative, in step S400, a displacement of the first tension wheel 92 (which includes a direction and a distance) is calculated, and a diameter of the first wire roller 94 is adjusted based on the displacement of the first tension wheel 92. It is noted that adjusting the diameter of the first wire roller 94 refers to adjusting a numeric value of a diameter parameter regarding the first wire roller 94 in the wire-running control program. Afterward, the multi-roller module system 9 is controlled to operate with the adjusted diameter parameter, and the flow goes back to step S200 to perform the inspection again.

On the other hand, when it is determined that the first tension wheel 92 is at the default location (i.e., no displacement), it may be deduced that the main rollers 91 and the first wire roller 94 are rotating synchronously, and an amount of the wire 96 moving away from the main rollers 91 in a given time period equals an amount of the wire 96 collected by the first wire roller 94 in the same time period. As such, the multi-roller module system 9 is said to be in a stable state, and the wire 96 is moving at a fixed linear speed. The method is thus terminated.

It is noted that while the multi-roller module system 9 may be adjusted to operate in the stable state, the fixed linear speed at which the wire 96 moves in the stable state may not necessarily equal the target linear velocity (V_{T}) designated in step S100, and therefore the presumed diameter (Rₛ) may not be necessarily equal to an actual diameter associated with the main rollers 91.

It is then beneficial to acquire an actual diameter of the main rollers 91 during operation of the multi-roller module system 9, such that the multi-roller module system 9 may operate with more stability. This is particularly useful in the field of high linear speed cutting manufacturing processes.

### SUMMARY

Therefore, one object of the disclosure is to provide a method for obtaining an overall diameter of a main roller included in a multi-roller module system.

According to one embodiment of the disclosure, the method is for obtaining a diameter of a rotatable main roller included in a multi-roller module system. The multi-roller module system further including a fixed-diameter rotating component, and a wire wound on the rotatable main roller and the fixed-diameter rotating component and to be driven to move by rotation of the rotatable main roller and the fixed-diameter rotating component, the method comprising steps of:

designating a target linear velocity (V_{T}) associated with the wire moving in the multi-roller module system, and a value of a presumed diameter parameter (Rₛ) associated with a diameter of the main roller;

activating the multi-roller module system to rotate the main roller and to drive the wire to move;

measuring a current rotational speed of the fixed-diameter rotating component when the multi-roller module system is running in a stable state in which the wire is moving at a constant linear speed;

calculating an actual linear velocity (V_{R}) of the wire based on the current rotational speed; and

comparing the target linear velocity (V_{T}) and the actual linear velocity (V_{R}) of the wire, increasing the value of the presumed diameter parameter (Rₛ) when it is determined that a ratio of the target linear velocity to the actual linear velocity is smaller than one, decreasing the value of the presumed diameter parameter (Rₛ) when it is determined that the ratio of the target linear velocity to the actual linear velocity is greater than one, and determining that the value of the presumed diameter parameter (Rₛ) equals an actual diameter (Rᵣ) of the main roller when it is determined that the ratio of the target linear velocity to the actual linear velocity is equal to one.

One effect of the method is that by obtaining the overall diameter of the main roller and performing adjustment accordingly, the chances of a tension wheel being displaced during operation of the multi-roller module system may be reduced, such that the multi-roller module system may operate with more stability. This is particularly useful in the field of high linear speed cutting manufacturing processes, such as ones with a wire moving at a velocity larger than 25 m/s. In the case the multi-roller module system is included in a wafer dicing system, a user executing the wafer dicing operation may be better informed of a status of the wire, such that the manufactured wafer may have a higher quality.

### BRIEF DESCRIPTION OF THE DRAWINGS

Other features and advantages of the disclosure will become apparent in the following detailed description of the embodiments with reference to the accompanying drawings, of which:

FIG. 1 is a schematic view illustrating a multi-roller module system, with the main components and structure being simplified;

FIG. 2 is a flow chart illustrating steps of a conventional method for determining a diameter of the main roller of the multi-roller module system;

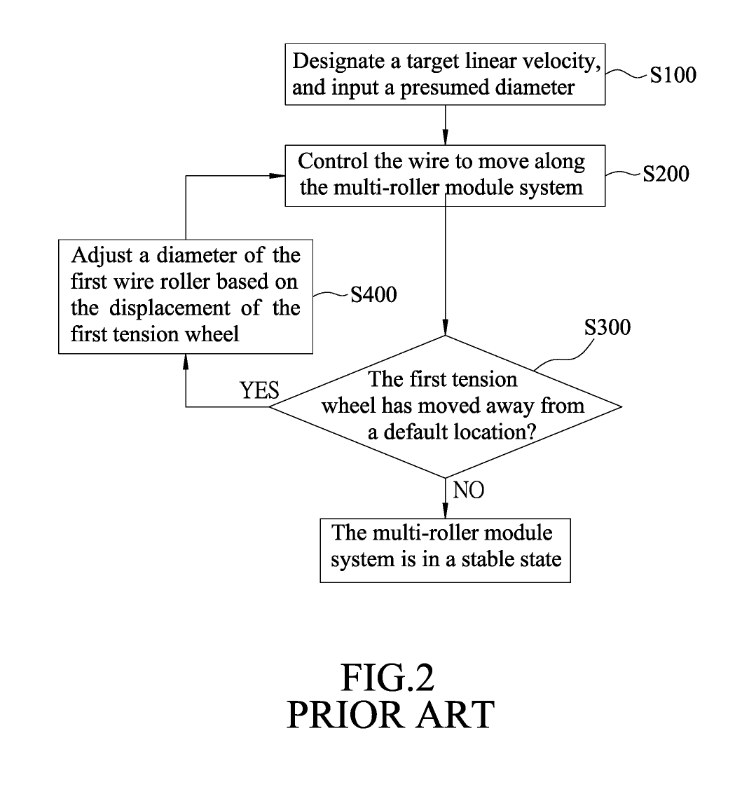

FIG. 3 is a flow chart illustrating steps of a method for obtaining a diameter of a main roller according to one embodiment of the disclosure;

FIG. 4 is a schematic view illustrating a multi-roller module system to which the method of the disclosure is applied;

FIG. 5 is a simplified schematic perspective view illustrating the multi-roller module system of FIG. 4;

FIG. 6 is a simplified schematic side view illustrating the multi-roller module system of FIG. 4;

FIG. 7 is a flow chart illustrating steps of a method for obtaining a diameter of a main roller according to one embodiment of the disclosure;

FIG. 8 is a schematic view illustrating another multi-roller module system to which the method of the disclosure is applied;

FIG. 9 is a schematic view illustrating another implementation of the multi-roller module system of FIG. 8; and

FIG. 10 is a schematic view illustrating yet another multi-roller module system, to which the method of the disclosure is applied.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

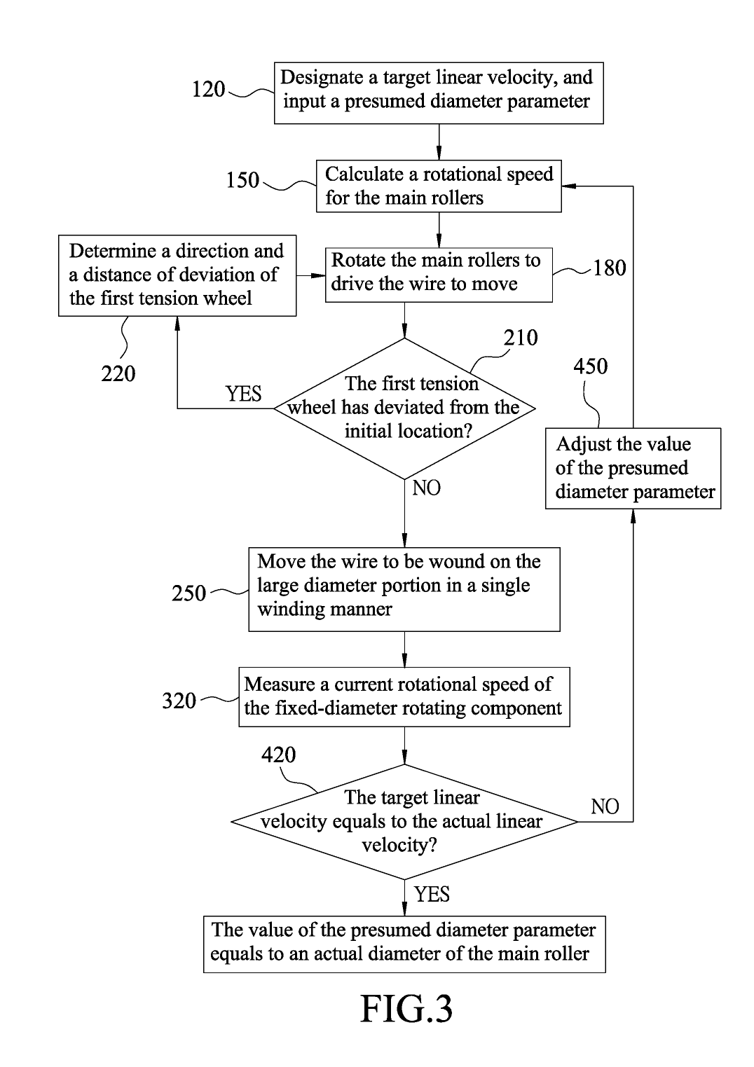

FIG. 3 is a flow chart illustrating steps of a method for obtaining a diameter of a main roller included in a multi-roller module system according to one embodiment of the disclosure.

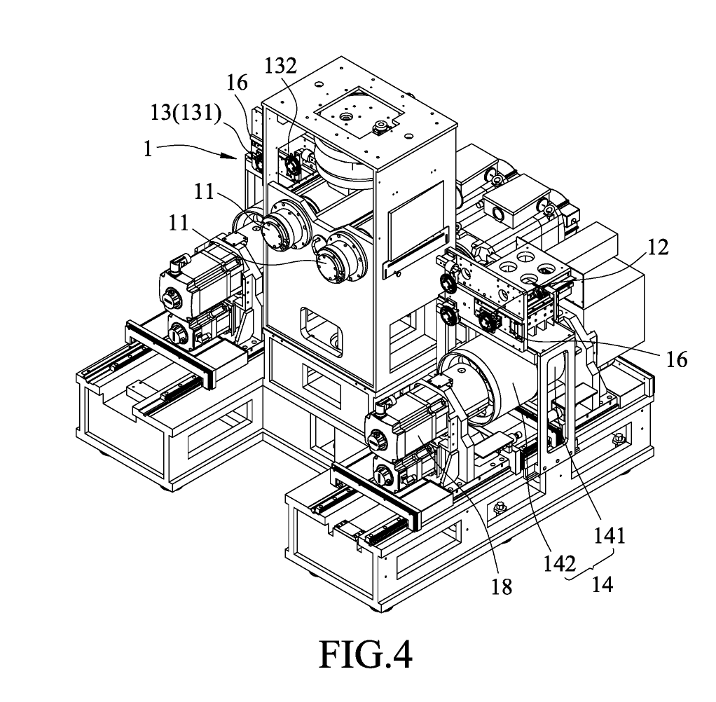

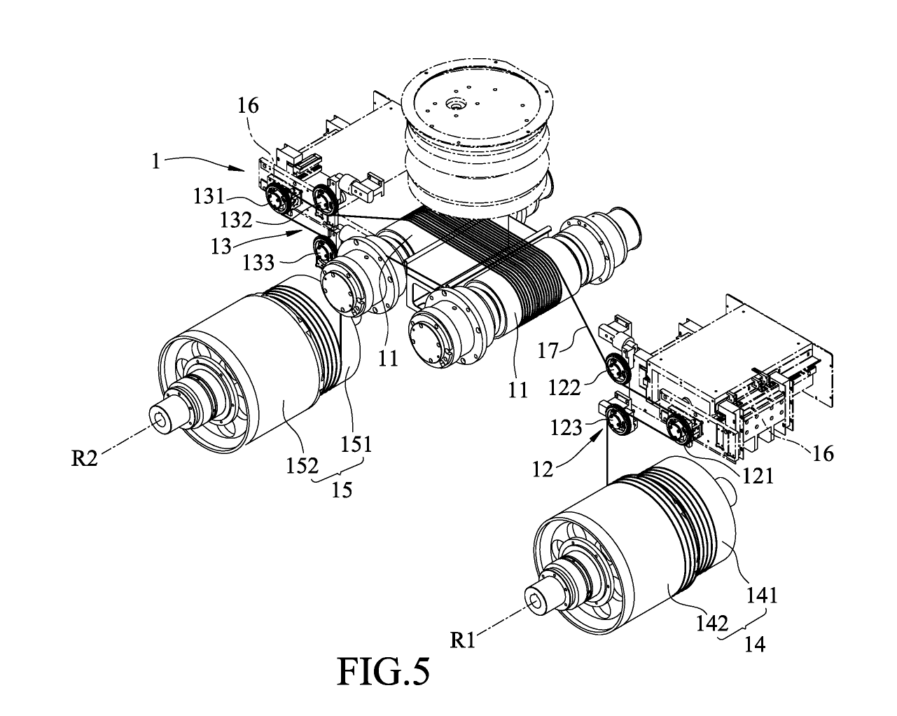

The method may be applied to a multi-roller module system 1 as illustrated by FIGS. 4 and 5, according to one embodiment of the disclosure. In this embodiment, the multi-roller module system 1 may be included in a wafer dicing machine, but in other embodiments, the multi-roller module system 1 may be included in, for example, a machinery for manufacturing tissue paper products.

The multi-roller module system 1 includes two rotatable main rollers 11, a first tension wheel set 12, a second tension wheel set 13, a first fixed-diameter rotating component 14, a second fixed-diameter rotating component 15, two tension adjustment components 16 and a wire 17. It is noted that in this embodiment, other than the tension adjustment components 16 and the wire 17, the components of the multi-roller module system 1 are rotatable.

The tension adjustment components 16 are connected to the first tension wheel set 12 and the second tension wheel set 13, respectively. The wire 17 is wound on the main rollers 11, the first tension wheel set 12, the second tension wheel set 13, the first fixed-diameter rotating component 14, and the second fixed-diameter rotating component 15. In operation, the wire 17 is driven to move by rotation of the main rollers 11, the first tension wheel set 12, the second tension wheel set 13, the first fixed-diameter rotating component 14, and the second fixed-diameter rotating component 15.

It is noted that the term “fixed-diameter rotating component” is used throughout the disclosure to indicate a rotatable component that includes at least a fixed-diameter portion on which the wire 17 runs in a single winding manner; that is to say, each turn of the wire 17 is directly wound on the fixed-diameter portion, and does not overlay another turn. In such a case, a diameter of each turn of the wire 17 on the fixed-diameter rotating component is fixed during operation of the multi-roller module system 1. In different embodiments, the fixed-diameter rotating component may be used to refer to different components that satisfy the above definition.

The first tension wheel set 12 is disposed between one of the main rollers 11 (i.e., a right one in FIG. 5) and the first fixed-diameter rotating component 14, and includes a first tension wheel 121 that allows the wire 17 to pass over and that is movable for adjusting tension of the wire 17, a first idler 122 that is disposed between the main roller 11 and the first tension wheel 121, and a second idler 123 that is disposed between the tension wheel 121 and the first fixed-diameter rotating component 14. The first and second idlers 122, 123 are configured for changing a direction of movement of the wire 17. The first fixed-diameter rotating component 14 includes a small diameter portion 141 having a first diameter with respect to an axis (R1), and a large diameter portion 142 connected coaxially with the small diameter portion 141 and having a second diameter that is larger than the first diameter with respect to the axis (R1). When in operation, the small diameter portion 141 and the large diameter portion 142 are capable of rotating synchronously with respect to the axis (R1).

The second tension wheel set 13 is disposed between the other one of the main rollers 11 (i.e., the left one in FIG. 5) and the second fixed-diameter rotating component 15, and includes a second tension wheel 131 that allows the wire 17 to pass over and that is movable for adjusting tension of the wire 17, a third idler 132 that is disposed between the main roller 11 and the second tension wheel 131, and a fourth idler 133 that is disposed between the second tension wheel 131 and the second fixed-diameter rotating component 15. The third and fourth idlers 132, 133 are configured for changing a direction of movement of the wire 17. The second fixed-diameter rotating component 15 includes a small diameter portion 151 having a first diameter with respect to an axis (R2), and a large diameter portion 152 connected coaxially with the small diameter portion 151 and having a second diameter that is larger than the first diameter with respect to the axis (R2). When in operation, the small diameter portion 151 and the large diameter portion 152 are capable of rotating synchronously with respect to the axis (R2). In this embodiment, each of the large diameter portions 142, 152 is a tubular piece, and is sleeved on a corresponding one of small diameter portions 141, 151. In other embodiments, however, each of the small diameter portions 141, 151 may be integrated with a corresponding one of the large diameter portions 142, 152 as one piece.

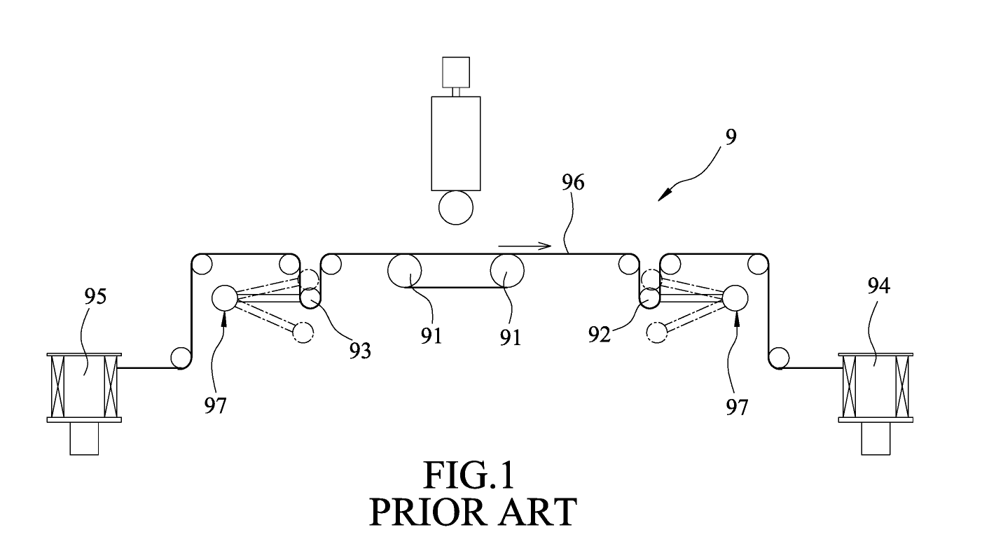

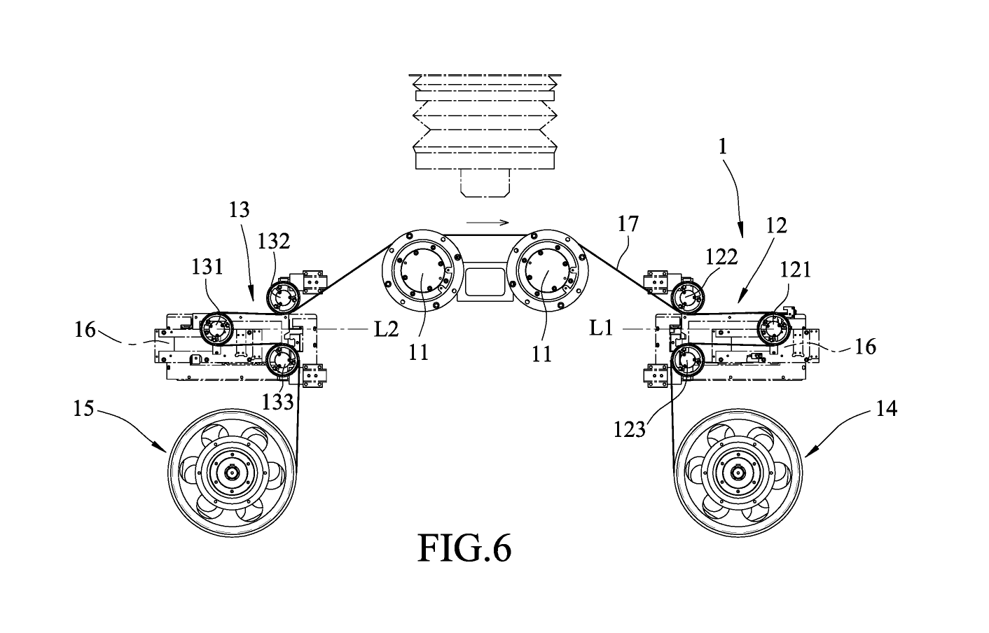

Further referring to FIG. 6, the tension adjustment components 16 are configured to adjust the tension of the wire 17 by moving the first tension wheel 121 and the second tension wheel 131. In this embodiment, each of the tension adjustment components 16 is configured to move the respective one of the first tension wheel 121 and the second tension wheel 131 along a straight line (i.e., lines (L1) and (L2) for the first tension wheel 121 and the second tension wheel 131, respectively). In other embodiments, the tension adjustment components 16 may be configured such that the first tension wheel 121 and the second tension wheel 131 move in a manner similar to that as shown in FIG. 1.

It is noted that prior to operation, each of the first tension wheel 121 and the second tension wheel 131 is located at a respective initial location.

The method may be implemented using a computing device (not depicted in the drawings) that executes a wire-running control program for controlling operations of the multi-roller module system 1 according to one embodiment of the disclosure, and details of the method are described in the following with reference to FIG. 3.

In step 100, a target linear velocity (V_{T}) associated with the wire 17 moving in the multi-roller module system 1 and a value of a presumed diameter parameter (Rₛ) associated with a diameter of one of the main rollers 11 are designated. In this embodiment, the designation may be done by a user entering the numeric values of the target linear velocity (V_{T}) and the presumed diameter parameter (Rₛ) using an interface of the computing device (not depicted in the drawings). In some embodiments, such as this one, the main rollers 11 are identical to one another (i.e., the diameter of one of the main rollers 11 is identical to the diameter of the other one of the main rollers 11).

In step 150, the computing device calculates a rotational speed (ω) for the main rollers 11 in the multi-roller module system 1, based on the value of the presumed diameter parameter (Rₛ) and the target linear velocity (V_{T}).

In step 180, the computing device activates the multi-roller module system 1 to rotate the main rollers 11 at the rotational speed (ω), and to drive the wire 17 to move.

At this stage, the wire 17 is driven to move uni-directionally from one of the first fixed-diameter rotating component 14 and the second fixed-diameter rotating component 15 to the other of the first fixed-diameter rotating component 14 and the second fixed-diameter rotating component 15. Specifically, in this embodiment, the wire 17 moves from the second fixed-diameter rotating component 15, via the main rollers 11, to the first fixed-diameter rotating component 14 (as indicated by the solid arrow shown in FIG. 6). Afterward, the wire 17 is wound on the small diameter portion 141 of the first fixed-diameter rotating component 14 in a multiple winding manner, thus performing wiring operations. The multiple winding manner is to wind the wire 17 on the small diameter portion 141 with multiple layers, so that each turn of the wire 17 on the small diameter portion 141 may overlay or be overlaid by another turn and a diameter of a bundle of the wire 17 wound on the small diameter portion 141 (i.e., a diameter of a turn of the wire 17 at the outermost layer) may vary during operation of the multi-roller module system 1.

In step 200, the computing device determines whether one of the first tension wheel 121 and the second tension wheel 131 has deviated from the respective initial location. In this embodiment, step 200 is to determine whether the first tension wheel 121 has deviated from the initial location.

When it is determined that the first tension wheel 121 has deviated from the respective initial location, the flow proceeds to step 220. Otherwise, the flow proceeds to step 250.

In step 220, the computing device determines a direction and a distance of deviation of the first tension wheel 121 from the initial location, and adjusts a diameter of the small diameter portion 141 based on a direction and a distance of deviation. Specifically, adjusting the diameter of the small diameter portion 141 refers to adjusting a diameter parameter associated with the diameter of the bundle of the wire 17 wound on the small diameter portion 141 used by the wire-running control program, or by a user manually inputting a desired diameter parameter, based on the direction and the distance of deviation. It is noted that the technique regarding the determination of the direction and the distance of deviation of the first tension wheel 121 from the respective initial location is known (e.g., as disclosed in U.S. patent application Ser. No. 15/960,682). In use, the first tension wheel 121 may be configured to transmitting a position signal via a transducer (not depicted in the drawings), so as to allow the direction and the distance of deviation of the first tension wheel 121 to be determined.

For example, when a rotational speed of the first fixed-diameter rotating component 14 becomes too high, the first tension wheel 121 may be driven to move in a left direction (as seen from the perspective of FIG. 6). In this case, the diameter parameter associated with the small diameter portion 141 should be reduced, so as to lower the rotational speed of the first fixed-diameter rotating component 14. On the other hand, when the rotational speed of the first fixed-diameter rotating component 14 becomes too low, the first tension wheel 121 may be driven to move in a right direction (as seen from the perspective of FIG. 6). In this case, the diameter parameter associated with the small diameter portion 141 should be increased, so as to increase the rotational speed of the first fixed-diameter rotating component 14. Afterward, the flow goes back to step 180, and determination may be repeated. When it is determined that the first tension wheel 121 still deviates from the initial location, the above process may be repeated until the first tension wheel 121 returns to the initial location. Then, the flow proceeds to step 250.

In step 250, when it is determined that the first tension wheel 121 does not deviate from the initial location, it may be deduced that an amount of wire 17 leaving the main rollers 11 in a given time period equals an amount of wire 17 that is wound on the first fixed-diameter rotating component 14. In such a case, the first fixed-diameter rotating component 14 is configured to move such that the wire 17 is subsequently wound on the large diameter portion 142 instead of the small diameter portion 141. In this embodiment, the wire 17 is wound on the large diameter portion 142 in a single winding manner, and thus the large diameter portion 142 is considered as a fixed-diameter portion.

After, when it is determined that the multi-roller module system 1 is running in a stable state, in which the wire 17 is moving at a constant linear speed for a predetermined time period, in step 300, the computing device measures a current rotational speed of the fixed-diameter rotating component 14. Specifically, the current rotational speed of the large diameter portion 142 of the fixed-diameter rotating component 14 is measured, so as to calculate an actual linear velocity (V_{R}) of the wire 17 based on the current rotational speed.

It is noted that since in this embodiment, the wire 17 is wound on the large diameter portion 142 in the single winding manner, a diameter of each turn of the wire 17 wound on the large diameter portion 142 may be considered a fixed value.

Additionally, in one implementation, the large diameter portion 142 of the fixed-diameter rotating component 14 is driven to rotate by a motor 18 (as shown in FIG. 4), and the current rotational speed of the large diameter portion 142 of the fixed-diameter rotating component 14 may be measured using a rotational speed of the motor 18. In other implementations, the current rotational speed of the large diameter portion 142 of the fixed-diameter rotating component 14 may be measured using a tachometer.

Afterward, in step 400, the computing device compares the target linear velocity (V_{T}) and the actual linear velocity (V_{R}) of the wire 17. Specifically, the computing device determines whether the following condition is met:

Rₛ/Rᵣ=V_{T}/V_{R}=1

When it is determined that the above condition is not met, the value of the presumed diameter parameter (Rₛ) is adjusted in step 450 based on a difference between the target linear velocity (V_{T}) and the actual linear velocity (V_{R}). When it is determined that a ratio of the target linear velocity (V_{T}) to the actual linear velocity (V_{R}) is smaller than 1 (i.e., V_{T}/V_{R}<1), the value of the presumed diameter parameter (Rₛ) is increased. When it is determined that a ratio of the target linear velocity (V_{T}) to the actual linear velocity (V_{R}) is smaller than 1 (i.e., V_{T}/V_{R}<1), the value of the presumed diameter parameter (Rₛ) is decreased.

On the other hand, when it is determined that the above condition is met, that is, the ratio of the target linear velocity (V_{T}) to the actual linear velocity (V_{R}) is equal to 1, it is determined that the value of the presumed diameter parameter (Rₛ) equals an actual diameter (Rᵣ) of the main roller 11. In some cases, the actual diameter (Rᵣ) may include a diameter of the main roller 11 and a dimension of the bundle of the wire 17 wound on the main roller 11 in a radial direction of the main roller 11.

Specifically, the target linear velocity (V_{T}) may be expressed as

V_{T}=(πRₛ)×(ω) (1)

(π×Rᵣ)×(ω)=V_{R} (2)

where V_{T} is the target linear velocity, Rₛ is the presumed diameter parameter, Rᵣ is the actual diameter of the main roller 11, V_{R} is the actual linear velocity, and ω is the rotational speed of the main rollers 11.

Based on Equations (1) and (2), the relationship between the presumed diameter parameter (Rₛ) and the actual diameter (Rᵣ) can be derived and is expressed as

(V_{T}/πRₛ)=(V_{R}/πRᵣ)→(V_{T}/V_{R})=(Rₛ/Rᵣ),

as such, when the ratio (V_{T}/V_{R}) of the target linear velocity (V_{T}) to the actual linear velocity (V_{R}) is equal to 1, then it can be deduced that the ratio of the presumed diameter parameter (Rₛ) to the actual diameter (Rᵣ) of the main roller 11 is also equal to 1 (i.e., the presumed diameter parameter (Rₛ) equals the actual diameter (Rᵣ) of the main roller 11).

When the ratio (V_{T}/V_{R}) is lower than 1, it can be deduced that the ratio of the presumed diameter parameter (Rₛ) to the actual diameter (Rᵣ) of the main roller 11 is also lower than 1 (i.e., the presumed diameter parameter (Rₛ) is smaller than the actual diameter (Rᵣ) of the main roller 11). In such a case, the presumed diameter parameter (Rₛ) should be increased since the actual diameter (Rᵣ) of the main roller 11 is an actual value.

When the ratio (V_{T}/V_{R}) is larger than 1, it can be deduced that the ratio of the presumed diameter parameter (Rₛ) to the actual diameter (Rᵣ) of the main roller 11 is also larger than 1 (i.e., the presumed diameter parameter (Rₛ) is larger than the actual diameter (Rᵣ) of the main roller 11). In such a case, the presumed diameter parameter (Rₛ) should be decreased.

After the value of the presumed diameter parameter (Rₛ) is adjusted in step 450, the flow goes back to step 150, and steps 180, 200, 250, 300 and optionally 220 are repeated. It is noted that in some embodiments, the adjustment of the value of the presumed diameter parameter (Rₛ) may be implemented by the wire-running control program in a gradual manner (e.g., adjusting the value by a relatively small amount each time). That is to say, the above steps may be iterated multiple times before the ratio (V_{T}/V_{R}) of the target linear velocity (V_{T}) to the actual linear velocity (V_{R}) becomes equal to 1 (i.e., the presumed diameter parameter (Rₛ) is equal to the actual diameter (Rᵣ) of the main roller 11).

The following Table 1 illustrated an exemplary procedure that iterates multiple times before obtaining the actual diameter (Rᵣ) of the main roller 11.

TABLE 1
V_{T} = 90 (m/min)

| | | Actual | | | |
|---|---|---|---|---|---|
| | | Rotational | Actual | | Relation |
| Presumed | | Speed of the | Linear | V_{T}/V_{R} | between |
| Diameter | | Wire Roller | Velocity | equal to | V_{T} & |
| Rₛ (mm) | | ω (rpm) | V_{R} (m/min) | 1? | V_{R} |
| Initial | 100 | 286.48 | 60 | No | V_{T}/V_{R} > 1, |
| | | | | | Lower Rₛ |
| First | 90 | 318.3 | 66.5 | No | V_{T}/V_{R} > 1, |
| adjustment | | | | | Lower Rₛ |
| Second | 80 | 358.1 | 74.8 | No | V_{T}/V_{R} > 1, |
| adjustment | | | | | Lower Rₛ |
| Third | 70 | 409.25 | 85.5 | No | V_{T}/V_{R} > 1, |
| adjustment | | | | | Lower Rₛ |
| Fourth | 68 | 421.29 | 88 | No | V_{T}/V_{R} > 1, |
| adjustment | | | | | Lower Rₛ |
| Fifth | 66 | 434.06 | 90.7 | No | V_{T}/V_{R} > 1, |
| Adjustment | | | | | Increase |
| | | | | | Rₛ |
| Sixth | 66.6 | 430.1 | 90 | Yes | V_{T}/V_{R} = 1, |
| adjustment | | | | | Rₛ = Rᵣ |

In the above example shown in Table 1, the target linear velocity (V_{T}) is 90 m/min, and the rotational speed of the main rollers 11 is calculated as 286.48 rpm based on the value of the presumed diameter parameter (Rₛ). Then, the main rollers 11 are activated to rotate at the rotational speed of 286.48 rpm, and the actual linear velocity (V_{R}) is measured for the first time at 60 m/min. Using the above equation (1), the amount of the adjustment of the presumed diameter parameter (denoted as ΔR) may be calculated as a ratio of the difference between the target linear velocity (V_{T}) and the actual linear velocity (V_{R}) (denoted as ΔV) to the rotational speed of the main rollers 11, specifically:

ΔV=(π×ΔR)×(ω), and

ΔR=ΔV/(π×ω).

Using the above values, the total amount of the adjustment of the presumed diameter parameter (ΔR) may be calculated as (90−60)*1000/(286.48*π)≈33.3 (mm).

It is noted that, however, during actual implementation, the amount of each adjustment may be further changed by the wire-running control program, due to reasons such as that the wire 17 may not be capable of enduring an abrupt change in tension resulted from the adjustment. As a result, it may be beneficial to adjust the value of the presumed diameter parameter (Rₛ) in a gradual manner (e.g., to impose a maximum amount of permitted adjustment in each iteration) when the difference between the target linear velocity (V_{T}) and the actual linear velocity (V_{R}) is large.

After it is determined in step 400 that the actual linear velocity (V_{R}) equals the target linear velocity (V_{T}), and the wire 17 is running on the large diameter portion 142 of the first fixed-diameter rotating component 14 and the large diameter portion 152 of the second fixed-diameter rotating component 15 in the single winding manner, the method may be optionally terminated, or repeated to continue monitoring the operation of the multi-roller module system 1.

It is noted that in some implementations, only one main roller 11, one tension wheel set 12 and one fixed-diameter rotating component 14 may be employed.

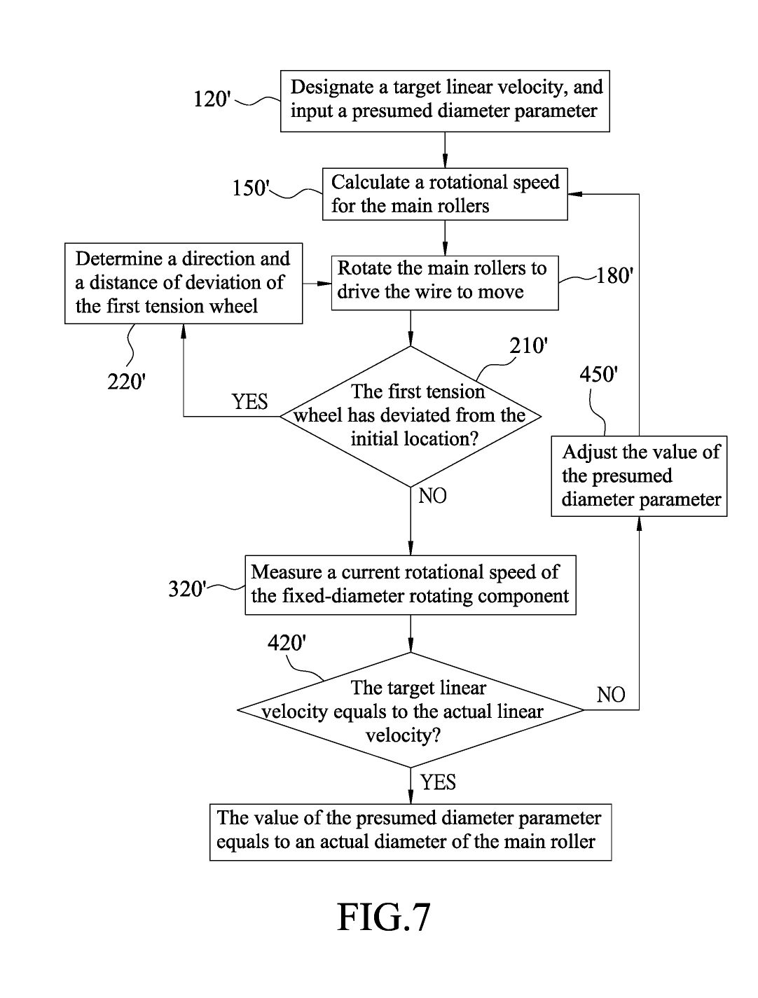

FIG. 7 is a flow chart illustrating steps of a method for obtaining a diameter of a main roller included in a multi-roller module system according to one embodiment of the disclosure.

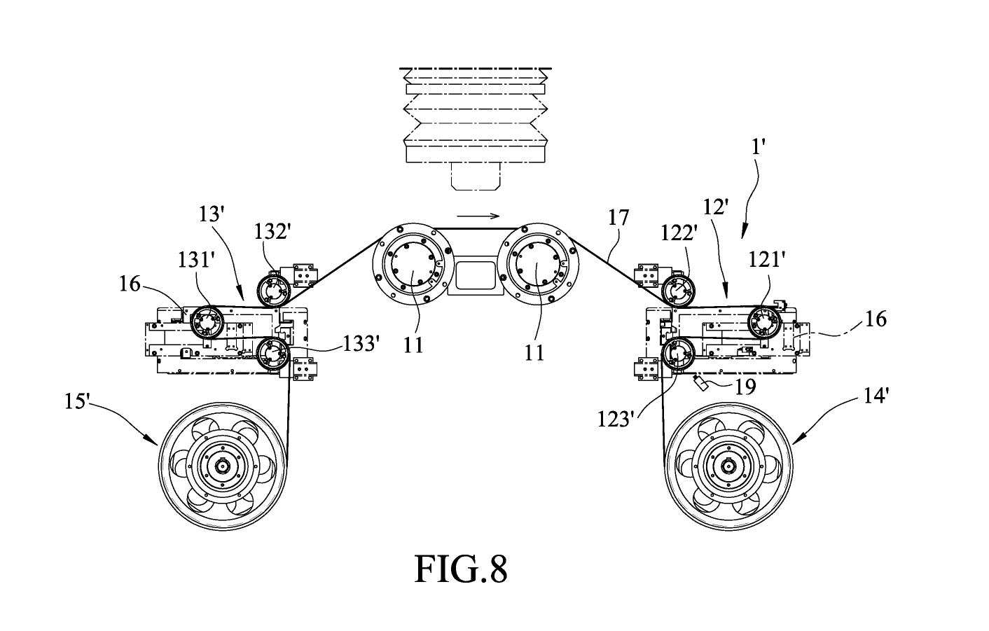

The method in this embodiment may be applied to a multi-roller module system 1′ as illustrated in FIG. 8, according to one embodiment of the disclosure.

The multi-roller module system 1′ includes two rotatable main rollers 11, a first tension wheel set 12′, a second tension wheel set 13′, a first wire winding roller 14′, a second wire winding roller 15′, two tension adjustment components 16, and a wire 17.

In operation, the wire 17 is wound on and driven to move by rotation of the main rollers 11, the first tension wheel set 12′, the second tension wheel set 13′, the first wire winding roller 14′, and the second wire winding roller 15′.

The first tension wheel set 12′ is disposed between one of the main rollers 11 (i.e., the right one in FIG. 8) and the first wire winding roller 14′, and includes a first tension wheel 121′ that allows the wire 17 to pass over and that is movable for adjusting tension of the wire 17, a first idler 122′ that is disposed between the main roller 11 and the first tension wheel 121′, and a first fixed-diameter rotating component 123′ (embodied using another idler that is not driven by a motor) that is disposed between the first tension wheel 121′ and the first wire winding roller 14′. The first idler 122′ and the first fixed-diameter rotating component 123′ are configured for changing a direction of movement of the wire 17.

The second tension wheel set 13′ is disposed between the other one of the main rollers 11 (i.e., the left one in FIG. 8) and the second wire winding roller 15′, and includes a second tension wheel 131′, a second idler 132′ that is disposed between the main roller 11 and the second tension wheel 131′, and a second fixed-diameter rotating component 133′ (embodied using another idler) that is disposed between the second tension wheel 131′ and the second wire winding roller 15′.

The tension adjustment components 16 are connected to the first tension wheel set 12′ and the second tension wheel set 13′, respectively, and are configured to adjust the tension of the wire 17 by moving the first tension wheel 121′ and the second tension wheel 131′.

Referring to FIG. 7, the method for obtaining a diameter of the main rollers 11 of the multi-roller module system l′ includes the following steps.

Each of steps 100′, 150′, and 180′ may be implemented in a manner that is similar to that of the corresponding step 100, 150, and 180, and details thereof are omitted herein for the sake of brevity.

At this stage, the wire 17 is driven to move uni-directionally. Specifically, in this embodiment, the wire 17 moves from the second wire winding roller 15′ to the first wire winding roller 14′ (as indicated by the solid arrow shown in FIG. 8). Afterward, the wire 17 is wound on the first wire winding roller 14′ in a multiple winding manner.

In step 200′, the computing device determines whether one of the first tension wheel 121′ and the second tension wheel 131′ (e.g., the first tension wheel 121′ in this embodiment) has deviated from its initial location.

When it is determined that the first tension wheel 121′ has deviated from the initial location, the flow proceeds to step 220′. Otherwise, the flow proceeds to step 300′.

In step 220′, the computing device determines a direction and a distance of deviation of the first tension wheel 121′ from the initial location, and adjusts a diameter of the first wire winding roller 14′ based on a direction and a distance of deviation. It is noted that the adjustment may be done as described in the previous embodiment. Afterward, the flow goes back to step 180′, and determination may be repeated. When it is determined that the first tension wheel 121′ still deviates from the initial location, the above process may be repeated until the first tension wheel 121′ returns to the initial location. Then, the flow proceeds to step 300′.

When it is determined that the multi-roller module system 1′ is running in a stable state, in which the wire 17 is moving at a constant linear speed for a predetermined time period, in step 300′, the computing device measures a current rotational speed of the first fixed-diameter rotating component 123′, so as to calculate an actual linear velocity (V_{R}) of the wire 17 based on the current rotational speed. In this embodiment, the current rotational speed of the first fixed-diameter rotating component 123′ may be measured using a tachometer 19 (see FIG. 8).

It is noted that in other embodiments, the first idler 122′ may be employed as the first fixed-diameter rotating component instead.

Then, in step 400′, the computing device compares the target linear velocity (V_{T}) and the actual linear velocity (V_{R}) of the wire 17. The details regarding the determination may be implemented in a way similar to step 400.

The embodiment as illustrated in FIGS. 7 and 8 differs from the previous embodiment in a number of ways. For example, the component employed as a fixed-diameter rotating component is different (in this embodiment, two of the idlers not motor-driven are employed).

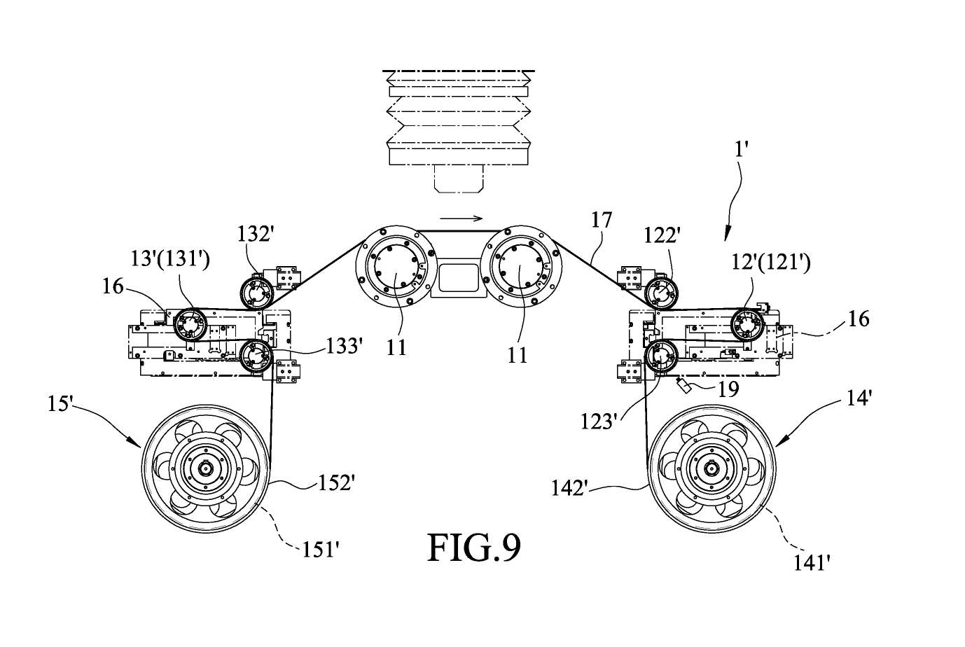

Additionally, in this embodiment, each of the first wire winding roller 14′ and the second wire winding roller 15′ has a uniform diameter. However, in another implementation as shown in FIG. 9, each of the first wire winding roller 14′ and the second wire winding roller 15′ may be in the form that is similar to those of the first fixed-diameter rotating component 14 and the second fixed-diameter rotating component 15. That is to say, for example, the first wire winding roller 14′ may include a small diameter portion 141′ having a first diameter, and a large diameter portion 142′ connected coaxially with the small diameter portion 141′ and having a second diameter that is larger than the first diameter. For example, the configuration of the first wire winding roller 14′ may be similar to that of the first fixed-diameter rotating component 14 (as seen in FIG. 5).

Moreover, since in this embodiment, the wire 17 is wound on the first wire winding roller 14′ in the multiple winding manner, the overall diameter of the first wire winding roller 14′ may vary during operation. As such, the computing device may be configured to initiate the method periodically.

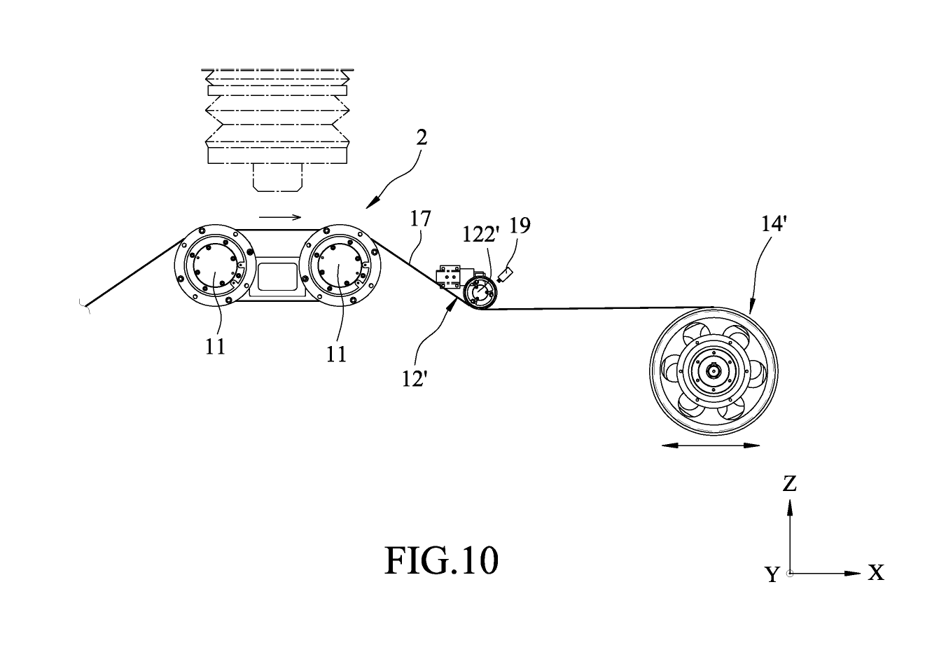

FIG. 10 illustrates partially a multi-roller module system 2 according to one embodiment of the disclosure. In this embodiment, the second tension wheel set 13′ and the tension adjustment components 16 may be omitted (compared to the multi-roller module system 1′ as shown in FIG. 8). In this embodiment, the first tension wheel set 12′ only includes an idler 122′. In this configuration, the tension of the wire 17 may be adjusted by moving the first wire winding roller 14′ along a horizontal direction (i.e., one parallel to the direction (X) as indicated in FIG. 10), since the tension of the wire 17 is directly related to a distance between the first wire winding roller 14′ and a nearer one of the main rollers 11.

As such, the method as illustrated in the previous embodiments may be applied to the multi-roller module system 2.

It is noted that a number of steps of the method of this disclosure are implemented differently when applied to the multi-roller module system 2. For example, step 200′ (see FIG. 7) may be implemented by the computing device determining whether a length of the wire 17 moving away from the main rollers 11 equals a length of the wire 17 collected by the first wire winding roller 14′. When it is determined that the length of the wire 17 moving away from the main rollers 11 equals the length of the wire 17 collected by the first wire winding roller 14′, the flow proceeds to step 300′.

On the other hand, when it is determined that the length of the wire 17 moving away from the main rollers 11 does not equal the length of the wire 17 collected by the first wire winding roller 14′, the flow proceeds to step 220′, in which the computing device controls the first wire winding roller 14′ to move along the horizontal direction for a predetermined distance with respect to the main rollers 11. Afterward, the flow goes back to step 180′.

In brief, the above-mentioned method disclosed in the embodiments of the disclosure may be applied to a general multi-roller module system having a wire running thereon. When it is determined that the multi-roller module system is running in the stable state in which the wire 17 is moving at a constant linear speed, and the multi-roller module system includes a rotatable component that can be designated as a fixed-diameter rotating component, and whose rotational speed can be measured (e.g., by the tachometer 19), the method is capable of calculating the actual linear velocity for comparison with the target linear velocity of the wire 17, and determining whether the presumed diameter parameter equals the overall diameter of the main roller 11.

In some embodiments, the method according to the embodiments of this disclosure may be implemented as one or more modules in executable software as a set of logic instructions stored in a machine-readable storage medium of a memory such as random access memory (RAM), read only memory (ROM), programmable ROM (PROM), firmware, flash memory, etc. In some embodiments, the method may be implemented using hardware elements, software elements or a combination of both.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for obtaining a diameter of a rotatable main roller included in a multi-roller module system, the multi-roller module system further including a fixed-diameter rotating component, and a wire wound on the rotatable main roller and the fixed-diameter rotating component and to be driven to move by rotation of the rotatable main roller and the fixed-diameter rotating component, the method comprising steps of:
a) designating a target linear velocity (V_{T}) associated with the wire moving in the multi-roller module system, and a value of a presumed diameter parameter (Rₛ) associated with a diameter of the main roller;
c) activating the multi-roller module system to rotate the main roller and to drive the wire to move;
d) measuring a current rotational speed of the fixed-diameter rotating component when the multi-roller module system is running in a stable state in which the wire is moving at a constant linear speed;
e) calculating an actual linear velocity (V_{R}) of the wire based on the current rotational speed; and
f) comparing the target linear velocity (V_{T}) and the actual linear velocity (V_{R}) of the wire, increasing the value of the presumed diameter parameter (Rₛ) when it is determined that a ratio of the target linear velocity to the actual linear velocity is smaller than one, decreasing the value of the presumed diameter parameter (Rₛ) when it is determined that the ratio of the target linear velocity to the actual linear velocity is greater than one, and determining that the value of the presumed diameter parameter (Rₛ) equals an actual diameter (Rᵣ) of the main roller when it is determined that the ratio of the target linear velocity to the actual linear velocity is equal to one.

2. The method of claim 1, further comprising, after step a): b) calculating a rotational speed (ω) for the main roller based on the value of the presumed diameter parameter (Rₛ) and the target linear velocity (V_{T});
wherein in step c), the main roller is controlled to rotate at the rotational speed (ω).

3. The method of claim 2, further comprising a step of repeating steps b) to f) when the ratio of the target linear velocity to the actual linear velocity is not equal to one.

4. The method of claim 1, the fixed-diameter rotating component including a small diameter portion having a first diameter, and a large diameter portion connected coaxially with the small diameter portion and having a second diameter that is larger than the first diameter, the multi-roller module system further including a tension wheel set disposed between the main roller and the fixed-diameter rotating component, the tension wheel set including a tension wheel that allows the wire to pass over and that is movable for adjusting tension of the wire, the wire being wound on the small diameter portion, the method further comprising, between steps c) and d), steps of:
c1) determining whether the tension wheel has deviated from an initial location;
c2) when it is determined that the tension wheel has deviated from the initial location, determining a direction and a distance of deviation of the tension wheel from the initial location, adjusting a diameter of the small diameter portion based on the direction and the distance of deviation, and repeating steps c) and c1); and
c3) when it is determined that the tension wheel is at the initial location, moving the wire from the small diameter portion to be wound on the large diameter portion in a single winding manner, and executing step d).

5. The method of claim 4, the tension wheel set further including a first idler disposed between the main roller and the tension wheel, and a second idler disposed between the tension wheel and the fixed-diameter rotating component, the first and second idlers (122, 123) being configured for changing a direction of movement of the wire.

6. The method of claim 5, wherein the tension wheel is configured to be moved along a straight line.

7. The method of claim 4, wherein the tension wheel is configured to be moved along a straight line.

8. The method of claim 2, the multi-roller module system further including a wire winding roller for collecting the wire from the fixed-diameter rotating component, the method further comprising, between steps a) and b):
a1) determining whether a length of the wire moving away from the main roller equals a length of the wire collected by the wire winding roller;
executing step b) when it is determined that the length of the wire moving away from the main roller equals the length of the wire collected by the wire winding roller; and
when it is determined that the length of the wire moving away from the main roller does not equal the length of the wire collected by the wire winding roller, controlling the wire winding roller to move along a horizontal direction with respect to the main roller, and repeating step a2).

9. The method of claim 2, the multi-roller module system further including a wire winding roller for collecting the wire from the fixed-diameter rotating component, and a tension wheel disposed at an initial location between the main roller and the wire winding roller for allowing the wire to be disposed around the tension wheel, the tension wheel being movable by a tension applied by the wire, the method further comprising, between steps a) and b):
a2) determining whether the tension wheel has deviated from the initial location;
when it is determined that the tension wheel has deviated from the initial location, determining a direction and a distance of deviation from the initial location, and adjusting a diameter of the wire winding roller based on the direction and the distance of deviation, and repeating steps a) and a2); and
when it is determined that the tension wheel is at the initial location, executing step b).

10. The method of claim 9, wherein the tension wheel is configured to moved along a straight line.

11. The method of claim 9, wherein the multi-roller module system further includes an idler disposed between the main roller and the wire winding roller, and the idler and the fixed-diameter rotating component are capable of changing a direction of movement of the wire.

12. The method of claim 11, wherein the tension wheel is configured to be moved along a straight line.

13. The method of claim 9, wherein the wire winding roller includes a small diameter portion having a first diameter, and a large diameter portion connected coaxially with the small diameter portion and having a second diameter that is larger than the first diameter, the small diameter portion and the large diameter portion being configured to rotate jointly.
